(19) United States
(12) Patent Application Publication
(10) Pub. No.: US 2019/0232297 A1
(43) Pub. Date: Aug. 1, 2019

(54) DISPENSER GUIDES

(71) Applicant: T2 Biosystems, Inc., Lexington, MA (US)

(72) Inventors: Eugenio DAVISO, Andover, MA (US); Christopher DEVLIN, Wakefield, MA (US); Steven Anthony SCAMPINI, Groton, MA (US)

(21) Appl. No.: 16/318,611

(22) PCT Filed: Jul. 20, 2017
(86) PCT No.: PCT/US2017/042992

§ 371 Date: Jan. 17, 2019

Related U.S. Application Data
(60) Provisional application No. 62/364,497, filed on Jul. 20, 2016.

(51) Int. Cl. B01L 9/00; B01L 3/02; B01L 3/00; G01N 35/10

(52) U.S. Cl. CPC B01L 9/543; B01L 3/0275; B01L 2200/025; G01N 35/1011; B01L 3/54

(57) ABSTRACT

The invention features devices, systems, and methods for introducing a sample (e.g., a biological sample, e.g., a blood sample) into a reaction vessel to maximize the effectiveness and/or reproducibility of introducing the sample (e.g., a biological sample, e.g., a blood sample).

### BACKGROUND OF THE INVENTION

Biological, biochemical, and biophysical assays often require that a liquid sample be dispensed into a container in a controllable and repeatable manner. Automated elements, such as automated pipettors, have been developed to standardize relevant parameters, such as the rate and volume of injection. However, in circumstances involving chemical or biological reactions, which are influenced by diffusion and convection of fluids, precise spatial control of a dispenser relative to a reaction vessel is necessary to reduce variance between measurements. In cases involving quantification of a sample over a period of time, precise temporal control over a sample dispenser may also be desirable.

Magnetic resonance can be used to monitor a variety of properties of a sample (e.g., a biological sample, e.g., blood). For example, coagulation rates and mechanisms can be determined by monitoring relaxivity or relaxation time, (e.g., transverse relaxation time (T2)) or diffusion of a blood sample over time after mixing with a coagulation activator. Such assays may require a series of frequent measurements of over a brief period of time, so precise control over the timing of sample dispensing is required. Furthermore, such measurements may require the sample to be positioned within a blind cavity, making it difficult to simultaneously achieve both spatial and temporal precision. Therefore, there is an unmet need in the field to develop a means to reproducibly dispense samples at a precise location, e.g., in a blind cavity.

### SUMMARY OF THE INVENTION

The present invention relates to devices for guiding sample dispensers (e.g., pipettors) in a laboratory environment. In one aspect, the invention provides a device having a hollow member having a top portion and a bottom portion, the top portion having a greater mean inner diameter and/or circumference than the bottom portion, wherein the top portion is sized and configured to receive the neck of a pipettor equipped with a pipette tip, and wherein the bottom portion is configured to couple with a reaction vessel (e.g., a capped reaction vessel). In some embodiments, the internal volume of the top portion is greater than the internal volume of the bottom portion. In some embodiments, the top portion includes a tapered internal surface (e.g., a linearly tapered or curvedly tapered internal surface). In some embodiments, depth reference markings can be included on the top portion to guide depth placement of the pipettor in the reaction vessel by the operator. In some embodiments, the hollow member has an internal stop element through which the pipette tip can be positioned within the reaction vessel. The internal stop element can be configured to position the pipette tip at a specified location within the lumen of the reaction vessel (e.g., a radially central point or a radially biased point within the lumen of the reaction vessel). In some embodiments, the internal stop element includes an inner lip (e.g., a tapered inner lip). In some embodiments, the hollow member is configured to retain fluid when coupled to the reaction vessel cap. In some embodiments, the internal stop element can limit the insertion depth of the pipettor into the reaction vessel.

In some embodiments, the device further includes a sleeve, which is configured to couple the reaction vessel with the bottom portion. The sleeve can be permanently attached to the bottom portion at a sleeve joint (e.g., a glued joint or a snap-fit joint). Alternatively, the sleeve can be configured to reversibly engage the bottom portion at a sleeve joint (e.g., a snap-fit joint or a screw-fit joint). In some embodiments, the reaction vessel is supported within the sleeve. All or a portion of the reaction vessel can be displaced below the bottom of the sleeve when supported within the sleeve. For example, 80% or more (e.g., 80%, 85%, 90%, 95%, or 100%) of the depth of the reaction vessel can be displaced below the sleeve.

In some embodiments, the rim of the reaction vessel is fitted with a reaction vessel cap. In some embodiments, the sleeve is configured to reversibly engage the reaction vessel or the reaction vessel cap at a vessel joint (e.g., a screw-fit or a snap-fit joint). A central portion of the reaction vessel cap can be configured to permit passage of the pipette tip therethrough (e.g., by puncture). In some embodiments, the reaction vessel cap is configured to retain gas, vapor, or heat prior to positioning the pipette tip in the reaction vessel. Alternatively, the reaction vessel cap can be configured to retain gas, vapor, or heat after positioning the pipette tip in the reaction vessel. The central portion of the reaction vessel cap can be made, wholly or partially, of santoprene or silicone. The central portion of the reaction vessel cap can also include foil (e.g., aluminum foil).

In any of the preceding embodiments, the hollow member can be made, wholly or partially, from a polymer (e.g., plastic, polypropylene, or polystyrene). The hollow member may further include an outer lip (e.g., for positioning the device within a holder, such as a staging element, e.g., as part of an instrument, e.g., a magnetic resonance instrument). In some embodiments, the outer lip is configured to contact a staging element for positioning the device within a magnetic resonance instrument. The staging element may be configured to lock the device into place within the magnetic resonance instrument. Additionally or alternatively, the outer lip can be configured to contact an ejection mechanism.

In some embodiments, a device of the invention can include a keying element (e.g., including a barcode) configured to interface with an electronic system (e.g., an electronic system having a robotic arm). In some embodiments, a fiducial marker can be incorporated into the device to determine the presence, depth, or angular orientation of the device within a magnetic resonance instrument.

In some embodiments, the device can be used in a hemostasis or blood clotting assay, e.g., to measure one or more characteristics of the coagulation pathway, e.g., a method as described in U.S. Patent Publication No. 2011/0312002, 2015/0369829, 2014/0212901, 2016/0018421, or 2015/0308970, or U.S. Provisional Patent Application No. 62/185,249, each of which is herein incorporated by reference. In other embodiments, the device can be used to detect the presence of a biomarker. In some embodiments, the device can be used in an endotoxin detection assay.

In another embodiment, the invention provides a system including the hollow member of the preceding embodiments, wherein a pipettor equipped with a pipette tip is within the hollow member. In some embodiments, the system further includes a capped reaction vessel connected to the hollow member, wherein the pipette tip is within a reaction vessel. In some embodiments, the reaction vessel (e.g., the capped reaction vessel) contains an agent (e.g., a lyophilized agent) to induce clotting of a dispensed blood sample.

In some embodiments, the invention features a method for loading a magnetic resonance instrument, the method including positioning the device of any of the preceding embodiments onto a stage, wherein a magnetic resonance instrument comprises the stage.

In some embodiments, the invention features a method for preparing a sample, the method including (a) positioning the device of any of the preceding embodiments onto a stage, wherein a magnetic resonance instrument comprises the stage; (b) inserting a pipettor equipped with a pipette tip into the hollow member; (c) contacting the pipettor with an internal wall of the hollow member; and (d) dispensing a sample into a reaction vessel. In some embodiments, the method further includes contacting the pipettor or the pipette tip with a stop element. In some embodiments, the method further includes puncturing a cap of the reaction vessel. In some embodiments, the method further includes dispensing a fluid into the reaction vessel (e.g., by automatic dispensing, e.g., by an automatic pipettor). In some embodiments or any of the preceding methods, one or more parameters associated with hemostasis or blood clotting is measured.

### Definitions

As used herein, a “top portion” of a hollow member refers to the segment including the opening of through which a pipettor enters, the segment of hollow member that is configured to contact the neck of a pipettor, and any portion therebetween. When an internal surface of a wall of the hollow member is part of the top portion, the entire thickness of the wall at that point is likewise taken as part of the top portion.

As used herein, a “bottom portion” of a hollow member refers to the segment including the joint (e.g., the point of attachment to a reaction vessel cap), the portion directly below the segment that is configured to contact the neck of the pipettor, and any portion therebetween. When an internal surface of a wall of the hollow member is part of the bottom portion, the entire thickness of the wall at that point is likewise taken as part of the bottom portion.

As used herein, a “sleeve” is a substantially hollow element that is connected to the hollow member (e.g., at the bottom portion of the hollow member) and the reaction vessel and/or the reaction vessel cap, thereby coupling the hollow member to the reaction vessel.

As used herein, a “keying element” is an element that interacts with an instrument by indicating the presence, location, and or other status of the element (e.g., as part of a dispenser guide) with the instrument. A keying element may include a material, pattern (e.g., a barcode), or circuitry (e.g., an RFID chip) that can be sensed by a sensor (e.g., an optical sensor, e.g., a camera and/or a barcode reader, or an electrical sensor, e.g., an RFID reader) within the instrument.

### BRIEF DESCRIPTION OF THE DRAWINGS

FIG. 1 is a photograph of a pipettor (1) equipped with a pipette tip (2) positioned within a dispenser guide (3).

FIG. 2A is a schematic drawing of a dispenser guide (3) in disassembled form. The dispenser guide (3) includes a hollow member (4), a sleeve (5), and a capped reaction vessel (6).

FIG. 2B is a photograph of a dispenser guide (3) in assembled form. The capped reaction vessel (6) is coupled to the hollow member (4) by the sleeve (5).

FIG. 3 is a schematic drawing of a hollow member (4), including a top portion (7) and a bottom portion (8). The top portion (7) has a tapered internal surface (9). An outer lip (10) is disposed along the outer circumference of the hollow member at the interface between the top portion and the bottom portion. A tapered inner lip (11) is disposed along the inner circumference at the bottom portion.

FIG. 4 is a schematic drawing of a sleeve (5). The inner walls of the sleeve (5) are indicated with dashed lines. The sleeve includes an inner ledge (15) configured to support a capped reaction vessel.

FIG. 5A is a schematic drawing of a capped reaction vessel (6). A reaction vessel (13) is fitted with a reaction vessel cap (12). An outer lip (14) is disposed along the outer circumference of the reaction vessel.

FIG. 5B is a photograph of a capped reaction vessel (6). A reaction vessel (13) is fitted with a reaction vessel cap (12). An outer lip (14) is disposed along the outer circumference of the reaction vessel.

FIG. 6 is a photograph of a top view of a reaction vessel cap (12) and a side view of a reaction vessel (13) without the cap fitted thereto.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The methods and devices of the invention can be used to facilitate dispensing of a sample, e.g., a blood sample, to a reaction vessel. Such methods can be used, e.g., for assessing the risk and occurrence of thrombotic events (e.g., clotting). For example, the methods and devices of the invention can be used to assess platelet reactivity (i.e., relative concentration of platelet-associated water molecules in a clot), clotting kinetics, clot strength, clot stability, and time-to-fibrin generation as indices for risk of a thrombotic event, such as myocardial ischemia, independent of responsiveness to drug therapy. These indices can also be used to prevent complications arising from surgical and percutaneous vascular procedures (e.g., stent placement or balloon angioplasty) such as stent thrombosis or re-stenosis. Additionally or alternatively, the methods and devices of the invention can be used for detection of biomarkers, infective agents, or endotoxin within a sample, e.g., according to methods described in U.S. Patent Publication No. 2014/0220594, which is herein incorporated by reference.

### Dispenser Guides

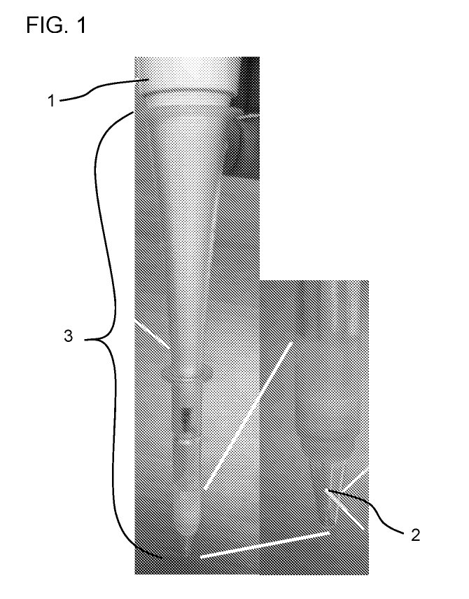

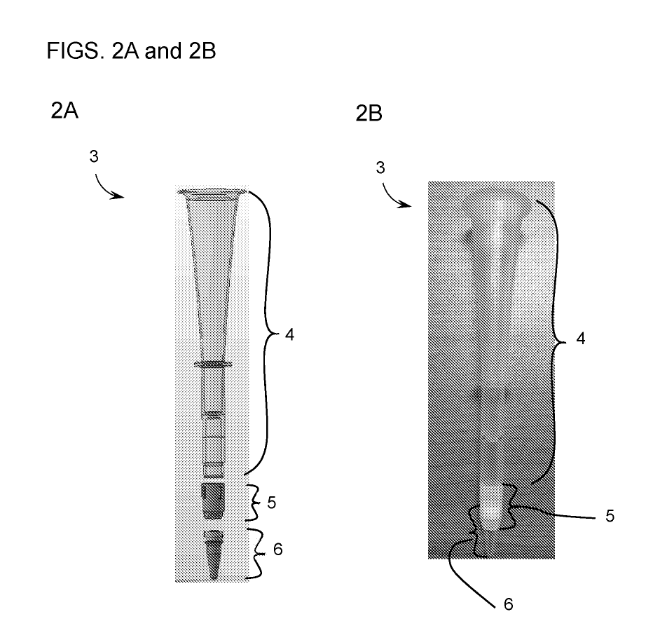

The devices of the invention involve hollow members, e.g., as part of a dispenser guide for dispensing a sample (e.g., a biological sample, e.g., a blood sample) into a reaction vessel (e.g., a tube or vial, e.g., a magnetic resonance vial). A dispenser guide of the invention may feature a hollow member configured to guide a sample (e.g., a biological sample, e.g., blood) to a precise location within a reaction vessel, e.g., to maximize the effectiveness and/or reproducibility of introducing the sample (e.g., a biological sample, e.g., a blood sample). By guiding the insertion of a pipettor as it descends toward the reaction vessel, a dispenser guide of the invention precisely positions a pipette tip fitted onto the pipettor and containing the sample within the reaction vessel. FIG. 1 shows an exemplary system including a dispenser guide (3) into which a pipettor (1) equipped with a pipette tip (2) has descended. FIGS. 2A and 2B show a disassembled configuration and an assembled configuration, respectively, of an exemplary dispenser guide of the invention.

### Hollow Member

The invention provides a dispenser guide having a hollow member with a top portion (i.e., the portion having an opening for entry of a pipettor) and a bottom portion (i.e., the portion through which the pipettor is designed to pass after passing through the top portion). Together, the top portion and the bottom portion function to guide a pipettor to centrally position its pipette tip as it descends through the hollow member toward the reaction vessel. The hollow member can be hermetically sealed upon coupling to a reaction vessel (e.g., at the interface between the hollow member and a sleeve), such that the hollow member is capable of retaining liquid within the interior of the dispenser device.

The top portion can be sized and/or configured to receive the neck of a pipettor equipped with a pipette tip. For example, the top portion can have a greater inner diameter or circumference (e.g., mean inner diameter, or mean inner circumference) at one or more points along its axis than the bottom portion. The top portion can have an inner diameter (e.g., a mean inner diameter, a minimum inner diameter, or a maximum inner diameter) of 5 mm or more (e.g., 5 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, or more). Accordingly, in some instances, the internal volume of the top portion is greater than the internal volume of the bottom portion. In some embodiments, a surface (e.g., an internal surface or an external surface) of the top portion is tapered (e.g., linearly tapered or curvedly tapered). Thus, the top portion may be substantially cone-shaped or funnel-shaped. In general, the top portion is configured to restrict lateral displacement (e.g., along the x-y plane) of the pipettor and/or pipette tip. Additionally or alternatively, the top portion can be configured to restrict tilting about a longitudinal axis (e.g., about the z axis) of the pipettor and/or pipette tip.

The bottom portion can have a size and shape suitable to accommodate lateral motion of the pipette tip resulting from the pipettor's movement as it descends the hollow member, e.g., prior to its contacting the internal surface of the top portion. A width permissive to such lateral motion can minimize contact of a pipette tip to the inner walls of the dispenser guide while the pipettor descends therethrough. The bottom portion can have an inner diameter (e.g., a mean inner diameter) of 20 mm or less (e.g., 20 mm, 19 mm, 18 mm, 17 mm, 16 mm, 15 mm, 14 mm, 13 mm, 12 mm, 11 mm, 10 mm, 9 mm, 8 mm, 7 mm, 6 mm, 5 mm, or less). The bottom portion of the hollow member can be configured to couple (e.g., directly or indirectly, e.g., through an intermediate element) with a reaction vessel.

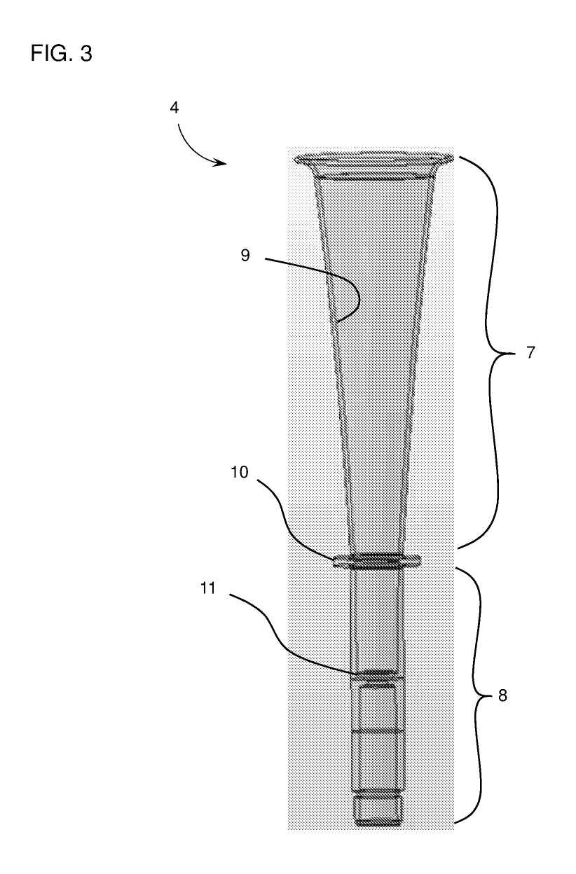

In some instances, the hollow member includes additional elements to help guide the pipettor and/or the pipette tip attached thereto. Such additional elements may include, e.g., depth reference markings to guide depth placement of the pipettor in the reaction vessel by the operator. In some instances, the hollow member includes an internal stop element (e.g., an inner lip), which prevents the pipette tip from descending too far toward the bottom of the reaction vessel (e.g., to prevent the pipette tip from contacting the bottom surface of the reaction vessel). The internal stop element can include one or more protrusions extending toward the central axis of the hollow member capable of obstructing downward motion of the pipettor. In one embodiment, the internal stop element is an inner lip (e.g., an internal protrusion that extends along all or a portion of the internal circumference of the hollow member). The internal stop element (e.g., an inner lip) can be tapered (e.g., at a top surface, e.g., at an angle similar to a tapered top portion). A tapered internal stop element (e.g., an inner lip) can function as a final guidance mechanism as the pipette tip approaches its final position, e.g., to fine-tune the location of the pipette tip (e.g., at a central point within the reaction vessel) after being progressively centralized by a tapered top portion. Additionally or alternatively, the tapered configuration of an internal stop element can facilitate passage of a pipette tip or other element of a pipettor, should it come into contact an internal side of the hollow member at a point above the internal stop element, e.g., to prevent “snagging” of a pipette tip on the internal stop element (e.g., an inner lip). FIG. 3 shows an exemplary hollow member (4) including a tapered inner lip (11).

An internal stop element can be positioned at any suitable point along the length of the hollow member. In some cases, the internal stop element (e.g., the inner lip) is positioned at the bottom portion of the hollow member. Alternatively, the internal stop element (e.g., the inner lip) can be positioned at the interface between the top portion and the bottom portion. In some embodiments, the internal stop element (e.g., the inner lip) is positioned within the bottom 50% of the length of the hollow member (e.g., within the bottom 50%, 40%, 30%, 20%, or 10% of the hollow member).

Additional elements can be included as part of the hollow member. In some instances, the hollow member includes an outer protrusion (e.g., an outer lip). The hollow member (3), shown by FIG. 3, includes an exemplary outer lip (10). An outer lip can function to position the hollow member (e.g., as part of a fully assembled dispenser guide) within a holder or a staging element (e.g., a staging element within an instrument, e.g., a magnetic resonance instrument). The staging element can be, for example, configured to support the device or lock the device into place within the instrument. Additionally or alternatively, the outer lip can be configured to contact all or a portion of an ejection mechanism that may be part of an instrument, thereby permitting ejection of the device from the instrument, e.g., upon completion of an assay.

All or a portion of a hollow member can be integrally formed (e.g., integrally molded) or can be an assembly of various parts. All or a portion of a hollow member can be made, wholly or partially, of a polymer (e.g., a plastic, polystyrene, or polypropylene).

### Sleeve

The bottom portion of the hollow member may be configured to couple to a reaction vessel through an intermediate element, such as a sleeve. A sleeve is a substantially hollow element that is connected to the hollow member (e.g., at the bottom portion of the hollow member) and the reaction vessel and/or the reaction vessel cap, thereby coupling the hollow member to the reaction vessel. The sleeve couples the reaction vessel to the hollow member and permits passing of the pipette tip from the interior of the hollow member to the reaction vessel (e.g., through the reaction vessel cap). FIGS. 2A and 2B show an exemplary sleeve (5) as part of a disassembled and assembled dispenser guide, respectively.

The sleeve can be permanently or removably attached to the bottom portion of the hollow member at a sleeve joint. In some instances, the sleeve is permanently attached to the bottom portion at a sleeve joint, e.g., a glued joint or a snap-fit joint (e.g., a permanent snap-fit joint). In embodiments having a permanently attached sleeve (e.g., including a permanent sleeve joint), the dispenser guide can be a disposable dispenser guide (e.g., configured for a single use). Alternatively, the sleeve can be removably attached to the bottom portion at a sleeve joint, e.g., a screw joint or a snap-fit joint (e.g., a removable snap-fit joint). A sleeve that can be removably attached to the bottom portion can be configured for multiple uses (e.g., as part of a reusable dispenser guide). The exemplary sleeve (5) shown as part of the dispenser guide (3) in FIGS. 2A and 2B is configured to be attached to the bottom portion of the hollow member by a snap-fit joint.

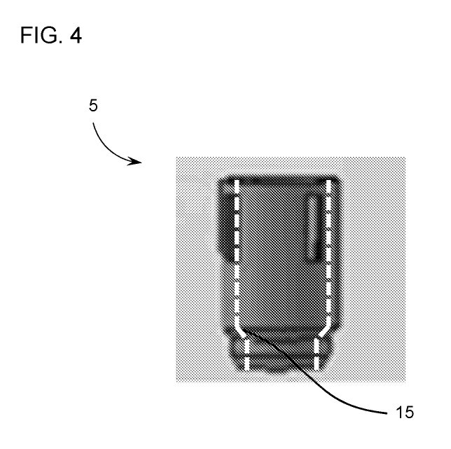

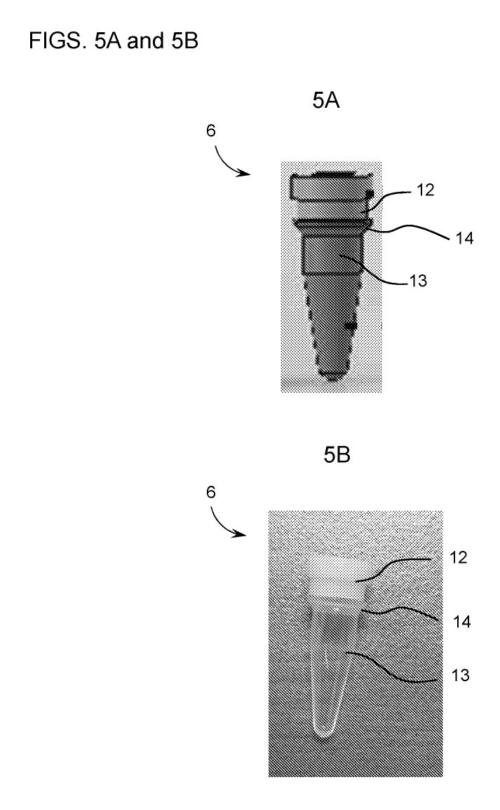

A sleeve of the invention can be configured to attach to a reaction vessel (e.g., a capped reaction vessel) by any suitable means. In some instances, the reaction vessel (e.g., the capped reaction vessel) can be supported within the sleeve at a vessel joint, as shown in FIG. 2B, such that all or a portion of the reaction vessel cap and/or a portion of the reaction vessel is within the interior of the sleeve (e.g., at the bottom of the sleeve). The interior of the sleeve can be configured to support the reaction vessel and/or the reaction vessel cap at the reaction vessel joint. In some embodiments, the inner wall of the sleeve includes a support element (e.g., an inner ledge circumscribing the inner circumference of the sleeve), on which a portion of the reaction vessel and/or reaction vessel cap can be supported. FIG. 4 shows an exemplary sleeve (5) having inner walls indicated with dashed lines. The bottom of the sleeve (5) has a smaller inner diameter than the top of the sleeve, due to the presence of an inner ledge (15). The inner ledge (15) is configured to support an outer lip (14) on the reaction vessel. An exemplary outer lip (14) of a reaction vessel (13) is shown in FIGS. 5A and 5B.

In some embodiments, the sleeve has a length configured to promote contact of the reaction vessel and/or reaction vessel cap with the bottom portion of the hollow member, e.g., upon snapping into place with the sleeve, thereby sandwiching the rim of the reaction vessel and/or the reaction vessel cap between the bottom portion of the hollow member and the support element (e.g., inner ledge) of the sleeve. Alternatively, the reaction vessel and/or the reaction vessel cap can be secured within the sleeve at a vessel joint by screwing into place or snapping into place (e.g., at a screw-fit joint or a snap-fit joint).

All or a portion of a sleeve can be integrally formed (e.g., integrally molded) or can be an assembly of various parts. All or a portion of a sleeve can be made, wholly or partially, of a polymer (e.g., a plastic, polystyrene, or polypropylene).

### Reaction Vessel

The bottom portion of the hollow member may be configured to couple (e.g., directly or indirectly, e.g., through an intermediate element, e.g., a sleeve) with a reaction vessel. The reaction vessel can be made of polymer (e.g., polystyrene, polypropylene, or any other suitable polymer). In some embodiments, the reaction vessel is substantially conical in shape. Alternatively, the reaction vessel can be substantially cylindrical, spherical, rectangular, or any suitable shape or a combination of shapes. In some cases, the reaction vessel is a reagent tube or vial commercially available for use for chemical or biological liquid handling, or a modification thereof. The reaction vessel may have a maximum capacity of 1,000 μl or less, (e.g., 1,000 μl, 900 μl, 800 μl, 750 μl, 700 μl, 600 μl, 500 μl, 400 μl, 300 μl, 250 μl, 200 μl, 150 μl, 100 μl, or less). In some embodiments, the reaction vessel has a maximum capacity of 200 μl.

In some embodiments, the reaction vessel includes an outer lip (e.g., the outer lip (14) of the capped reaction vessel (6) shown in FIGS. 5A and 5B) to facilitate positioning within a sleeve. For example, an outer lip can project radially outward, extending to a radius that is greater than the radius of the bottom opening of a sleeve and less than the radius of the top opening of the sleeve, i.e., enabling its positioning within the sleeve, e.g., by being supported at the interface of the bottom of the outer lip and an inner surface of the sleeve (e.g., a support element, e.g., an inner ledge, e.g., at a bottom portion of the sleeve). In some embodiments, this interface creates a hermetic seal to prevent leakage of liquid from the dispenser guide. The outer lip may extend partially or fully around the outer circumference of the reaction vessel and/or may be tapered. In some cases, the outer lip is located near the rim of the reaction vessel (e.g., near the top, e.g., within the top 10%, 20%, 30%, 40%, or 50% of the length of the reaction vessel). In some cases, the outer lip is located at a position along the length of the reaction vessel that results in 20% or more (e.g., 20%, 30%, 40%, 50%, 60%, 70%, 80% or more) of the length of the reaction vessel to project from beneath the bottom opening of the sleeve, e.g., to be exposed for analysis, e.g., as part of a magnetic resonance assay.

A reaction vessel may additionally include a penetrable seal residing underneath the cover. The penetrable seal may easily be punctured with a pipet tip or other device. This seal may consist of foil (e.g., aluminum foil), paper, plastic, or other material that has a plastic coating on one side (e.g., a polypropylene-coated foil).

In some embodiments, the reaction vessel may contain an agent to induce a reaction upon exposure to a sample. In some cases, the agent induces blood clotting upon dispensing of a blood sample into the reaction vessel. Such agents are known in the art and include, e.g., kaolin (CK), ellagic acid, celite, RPF, TRAP, epinephrine, collagen, batroxobin (reptilase, ecarin, factor XIIIa, tissue factor, thromboplastin, Innovin, readiplastin, ristocetin, thrombin, calcium, prothrombin, serotonin, platelet activating factor (PAF), thromboxane A2 (TXA2), fibrinogen, von Willebrand factor (VFW), elastin, fibrinonectin, laminin, vitronectin, thrombospondin, lanthanide ions (e.g., lanthanum, europium, ytterbium, etc.), and combinations thereof. The reaction vessel may contain any suitable amount of one or more agents in liquid or solid form (e.g., as a lyophilized powder).

### Reaction Vessel Cap

The invention further provides a dispenser guide wherein the rim of the reaction vessel is fitted with a reaction vessel cap. The reaction vessel cap can be fitted to the rim of the reaction vessel by any suitable means including, but not limited to, by snapping into place (e.g., at the inner and/or outer surface of the reaction vessel) or screwing into place. In some cases, the reaction vessel cap forms a hermetic seal around the rim of the reaction vessel to prevent liquids and gases from transferring in or out of the reaction vessel.

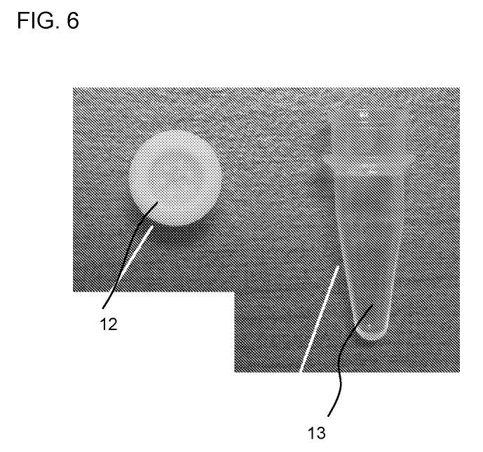

The reaction vessel cap can be configured to allow passage of a pipette tip therethrough. For example, a central region of the cap can be less resistant to puncture than surrounding regions to facilitate central alignment of the pipette tip as it enters the reaction vessel. In some embodiments, the thickness of the cap is reduced at a central region (e.g., at one or more points or lines at or near the central region) to render it mechanically vulnerable to puncture by a pipette tip. In some embodiments, the reaction vessel cap conforms to the outer surface of the pipette tip after the pipette tip has punctured the cap (e.g., when the pipette tip is within the reaction vessel). In this case, the cap may form a hermetic seal at its interface with the pipette tip. The extent to which the cap conforms to the outer surface of a pipette tip (e.g., the pressure at which the cap contacts the pipette tip at one or more points along its outer circumference) will be determined by the properties of the cap material, e.g., its compliance, stiffness, and/or elasticity. Additionally or alternatively, the reaction vessel cap can be configured to form a hermetic seal at its interface with the inner walls of the sleeve (e.g., at the outer circumference of the cap, e.g., to retain liquids within the dispenser guide, e.g., within the sleeve and/or hollow member). FIG. 6 shows a top view of an exemplary reaction vessel cap (12) next to a reaction vessel (13) configured to be fitted with the reaction vessel cap (12).

Suitable materials that may be included as part of a cap of the device (e.g., at a central region of the cap) include, but are not limited to, polymers, e.g., an elastomeric polymer, such as santoprene, silicone, PVC, or rubber (e.g., synthetic rubber or natural rubber). Various geometries (e.g., patterns and thicknesses) of mechanical vulnerabilities in the cap can be used as part of the invention, according to known physical principles and will depend on the properties of the material used.

### Keying Element

A device of the invention may further feature a keying element configured to interface with an electronic system. For example, a keying element may facilitate an automation or robotic interface (e.g., a device including a robotic arm). In some embodiments, a keying element may unlock one or more features of an instrument (e.g., when sensed as within or in the proximity of the instrument). Additionally or alternatively, a keying element may provide information to the instrument regarding the position (e.g., the location and/or angular orientation) of the dispenser guide, e.g., relative to a pipettor or relative to the magnetic resonance instrument. In some cases, a keying element can prevent undesired pipetting (e.g., pipetting that may occur at the wrong time or place, e.g., as a result of misplacement of a pipettor) by sensing the position of the pipettor and/or hollow member, e.g., using a software interface. In some cases, the keying element can interact with a mechanical subsystem (e.g., a lock) of the instrument to prevent premature insertion of a device of the invention into the instrument and/or premature removal of a device of the invention from the instrument. A keying element may also facilitate proper placement (e.g., manual insertion) of the device into the instrument by providing reference (e.g., mechanical and/or visual feedback) of the position (e.g., depth, lateral position, or angular orientation) of the device, e.g., relative to the instrument.

A keying element may include a material (e.g., a fiducial marker), pattern (e.g., a barcode), or circuitry (e.g., an RFID chip) that can be sensed by a sensor (e.g., an optical sensor, e.g., a camera and/or a barcode reader, or an electrical sensor, e.g., an RFID reader) within the instrument. An optical sensor can be, e.g., designed to detect the presence of a pipettor. In some embodiments, a keying element includes an indentation, reflective region, color-coded portion, metallic portion, or a mechanical element (e.g., a button or lever, e.g., as part of a capacitance-sensitive mechanism). A keying element can be located at any suitable location on a device of the invention including, but not limited to, the outer lip or any other region of the hollow member, the reaction vessel, the reaction vessel cap, or the sleeve.

### Methods

The present invention also includes methods for loading a magnetic resonance instrument and methods for preparing a sample (e.g., a biological sample, e.g., for a magnetic resonance assay). In one aspect, the invention provides a method for loading a magnetic resonance instrument by positioning a device of the invention (e.g., a dispenser guide) onto a stage (e.g., a stage that is part of a magnetic resonance instrument). The stage can be external to the instrument or internal to the instrument, or the stage can insert into the instrument after positioning the device onto the stage.

In another aspect, the invention features a method for preparing a sample (e.g., a biological sample, such as a blood sample). A device of the invention (e.g., a dispenser guide) can be positioned onto a stage of a magnetic resonance instrument, e.g., to position the dispenser guide for insertion of a pipettor. Next, a pipettor equipped with a pipette tip containing a sample is inserted into the hollow member, e.g., through an automated processes or manually. As the pipettor descends through the hollow member toward the reaction vessel, the pipettor is brought into contact with an internal wall of the hollow member (e.g., an internal wall of the top portion of the hollow member). The pipettor continues to descend through the hollow member and may or may not remain in contact with an internal wall. As the pipettor descends toward the reaction vessel, it may gradually become centrally aligned (e.g., such that the pipette tip is at or near the central longitudinal axis of the reaction vessel). In some embodiments, the pipette tip will eventually contact the reaction vessel cap and puncture it (e.g., at a central portion of the reaction vessel cap). The pipettor may continue to descend until it, or a portion of the pipette tip, is physically obstructed by the hollow member or an element thereof (e.g., a stop element, such as an inner lip). Once the pipettor is fully inserted into the device, the orifice of the pipette tip is positioned within the reaction vessel. In some cases, the central longitudinal axis of the pipette tip is within 2.0 mm of the central longitudinal axis of the reaction vessel (e.g., within 2.0 mm, 1.9 mm, 1.8 mm, 1.7 mm, 1.6 mm, 1.5 mm, 1.4 mm, 1.3 mm, 1.2 mm, 1.1 mm, 1.0 mm, 0.9 mm, 0.8 mm, 0.7 mm, 0.6 mm, 0.5 mm, 0.4 mm, 0.3 mm, 0.2 mm, 0.1 mm, 0.09 mm, 0.08 mm, 0.07 mm, 0.06 mm, 0.05 mm, 0.04 mm, 0.03 mm, 0.02 mm, 0.01 mm, or less of the central longitudinal axis of the reaction vessel). In some cases, the orifice of the pipette tip is positioned between 1.0 and 10 mm from the bottom surface of the reaction vessel (e.g., 1.0 mm, 2.0 mm, 2.5 mm, 3.0 mm, 3.5 mm, 4.0 mm, 4.5 mm, 5.0 mm, 5.5 mm, 6.0 mm, 6.5 mm, 7.0 mm, 7.5 mm, 8.0 mm, 8.5 mm, 9.5 mm, or 10 mm from the bottom surface of the reaction vessel). The sample (e.g., a biological sample, e.g., a blood sample) can then be dispensed (e.g., manually or automatically).

Pipettors and pipette tips suitable for use in the methods of the invention include any pipettors or pipette tips having adequate geometries. For example, the outer surface of the neck of a pipettor may have a shape that corresponds with the shape of the inner surface of a portion of the hollow member (e.g., a top portion). Any suitable pipette tip can be used as part of a method of the invention. A pipette tip may have a constant width at all or a portion of its length (e.g., at a length corresponding to the distance between the reaction vessel cap and the orifice of the pipette tip). In some embodiments, a pipette tip has a maximum capacity of 50 μl or less.

The volume of the sample (e.g., a biological sample, e.g., blood) dispensed from the pipette tip can be 1,000 μl or less (e.g., 1,000 μl, 900 μl, 800 μl, 700 μl, 600 μl, 500 μl, 400 μl, 300 μl, 250 μl, 200 μl, 150 μl, 100 μl, 90 μl, 80 μl, 70 μl, 60 μl, 50 μl, 45 μl, 40 μl, 35 μl, 30 μl, 25 μl, 20 μl, 15 μl, 10 μl, or less). In some embodiments, 35 μl of blood is dispensed.

### Other Embodiments

Various modifications and variations of the described method and system of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention that are obvious to those skilled in the art are intended to be within the scope of the invention.

Other embodiments are in the claims.

What is claimed is:

1. A device comprising a hollow member comprising a top portion and a bottom portion, the top portion having a greater mean inner diameter than the bottom portion, wherein the top portion is sized and configured to receive the neck of a pipettor equipped with a pipette tip, and wherein the bottom portion is configured to couple with a reaction vessel.

2. The device of claim 1, wherein the internal volume of the top portion is greater than the internal volume of the bottom portion.

3. The device of claim 1 or 2, wherein the top portion comprises a tapered internal surface.

4. The device of any one of claims 1-3, the hollow member comprising an internal stop element through which the pipette tip can be positioned within the reaction vessel.

5. The device of claim 4, wherein the internal stop element is configured to position the pipette tip at a specified location within the lumen of the reaction vessel.

6. The device of claim 4 or 5, wherein the internal stop element comprises an inner lip.

7. The device of any one of claims 4-6, wherein the internal stop element is tapered.

8. The device of any one of claims 1-7, wherein the hollow member is configured to retain fluid when coupled to the reaction vessel cap.

9. The device of any one of claims 1-8, further comprising a sleeve, wherein the sleeve is configured to couple the reaction vessel with the bottom portion.

10. The device of any one of claims 1-8, wherein the sleeve is permanently attached to the bottom portion at a sleeve joint.

11. The device of claim 10, wherein the sleeve joint is a glued joint.

12. The device of any one of claims 1-8, wherein the sleeve is configured to reversibly engage the bottom portion at a sleeve joint.

13. The device of claim 10 or 12, wherein the sleeve joint is a snap-fit joint.

14. The device of claim 12, wherein the sleeve joint is a screw-fit joint.

15. The device of any one of claims 1-14, wherein the reaction vessel is supported within the sleeve.

16. The device of claim 15, wherein all or a portion of the reaction vessel is displaced below the bottom of the sleeve when supported within the sleeve.

17. The device of any one of claims 1-16, wherein the rim of the reaction vessel is fitted with a reaction vessel cap.

18. The device of claim 17, wherein the sleeve is configured to reversibly engage the reaction vessel or the reaction vessel cap at a vessel joint.

19. The device of claim 18, wherein the vessel joint is a screw-fit joint or a snap-fit joint.

20. The device of any one of claims 1-19, wherein a central portion of the reaction vessel cap is configured to permit passage of the pipette tip therethrough.

21. The device of claim 20, wherein the passage of the pipette tip is a puncture.

22. The device of any one of claims 17-21, wherein the reaction vessel cap is configured to retain gas, vapor, or heat prior to positioning the pipette tip in the reaction vessel.

23. The device of any one of claims 17-22, wherein the reaction vessel cap is configured to retain gas, vapor, or heat after positioning the pipette tip in the reaction vessel.

24. The device of any one of claims 17-23, wherein the central portion of the reaction vessel cap comprises santoprene.

25. The device of any one of claims 17-23, wherein the central portion of the reaction vessel cap comprises silicone.

26. The device of any one of claims 17-23, wherein the central portion of the reaction vessel cap comprises foil.

27. The device of any one of claims 1-26, wherein the hollow member comprises plastic.

28. The device of claim 27, wherein the plastic is polypropylene.

29. The device of any one of claims 1-28, wherein the hollow member comprises an outer lip for positioning the device within a holder.

30. The device of claim 29, wherein the outer lip is configured to contact a staging element for positioning the device within a magnetic resonance instrument.

31. The device of claim 30, wherein the staging element is configured to lock the device into place within the magnetic resonance instrument.

32. The device of any one of claims 29-31, wherein the outer lip is configured to contact an ejection mechanism.

33. The device of any one of claims 1-32, further comprising a keying element configured to interface with an electronic system.

34. The device of claim 33, wherein the electronic system comprises a robotic arm.

35. The device of any one of claims 1-34, wherein the hollow member is connected to a capped reaction vessel.

36. The device of any one of claims 1-35, wherein the device is for use in a blood clotting assay.

37. The device of any one of claims 1-36, wherein the device is for use in an endotoxin detection assay.

38. A system comprising the hollow member of any one of claims 1-37, wherein a pipettor equipped with a pipette tip is within the hollow member.

39. The system of claim 38, further comprising a capped reaction vessel connected to the hollow member, wherein the pipette tip is within a reaction vessel.

40. The system of claim 38 or 39, wherein the capped reaction vessel contains an agent to induce clotting of a dispensed blood sample.

41. A method for loading a magnetic resonance instrument, the method comprising positioning the device of any one of claims 1-37 onto a stage, wherein the magnetic resonance instrument comprises the stage.

42. A method for preparing a sample, the method comprising:
(a) positioning the device of any one of claims 1-37 onto a stage, wherein a magnetic resonance instrument comprises the stage;
(b) inserting into the hollow member a pipettor equipped with a pipette tip containing the sample;
(c) contacting the pipettor with an internal wall of the hollow member; and
(d) dispensing the sample into a reaction vessel.

43. The method of claim 42, further comprising contacting the pipettor or the pipette tip with a stop element.

44. The method of claim 43, further comprising puncturing a cap of the reaction vessel.

45. The method of any one of claims 41-44, wherein the dispensing is automatic.

46. The method of any one or claims 41-45, further comprising measuring one or more parameters associated with hemostasis or blood clotting.
